(19) United States
(12) Patent Application Publication
(10) Pub. No.: US 2026/0083281 A1
(43) Pub. Date: Mar. 26, 2026

(54) AUTOMATIC CULINARY SYSTEM

(71) Applicant: Kuang Cheng Catering Limited Company, Kaohsiung City (TW)

(72) Inventor: Yi-Chung CHENG, Kaohsiung City (TW)

(21) Appl. No.: 18/958,136

(22) Filed: Nov. 25, 2024

(30) Foreign Application Priority Data
Sep. 25, 2024 (TW) 113136432

(51) Int. Cl. A47J 44/00; B25J 11/00

(52) U.S. Cl. CPC A47J 44/00; B25J 11/0045

(57) ABSTRACT

An automatic culinary system includes a central control unit, an actuation unit, a seasoning supply unit, a sauce supply unit, and a mixer unit. The seasoning supply unit includes a plurality of seasoning storage barrels, a plurality of seasoning output modules, and a seasoning operation interface operable for outputting a seasoning amount signal to one of the plurality of seasoning output modules for outputting one of different types of seasoning powder from a respective one of the plurality of seasoning storage barrels. The sauce supply unit includes a plurality of sauce storage barrels, a plurality of sauce dispenser modules, and a sauce operation interface operable for outputting a usage signal to one of the plurality of sauce dispenser modules for outputting one of different types of sauces from a respective one of the plurality of sauce storage barrels. The mixer unit includes a mixer mechanism and a mixer actuation mechanism.

### CROSS-REFERENCE TO RELATED APPLICATION

This application claims priority to Taiwanese Invention Patent Application No. 113136432, filed on Sep. 25, 2024, the entire disclosure of which is incorporated by reference herein.

### FIELD

The disclosure relates to an automatic system, and more particularly to an automatic culinary system.

### BACKGROUND

When creating a dish, aside from the basic ingredients and toppings, factors including the timing and amount of added water and seasoning powder could also greatly affect the flavors and presentation of the dish. Moreover, cooking methods, timing, and control over temperature of the stove are also factors that could affect the final presentation of the dish. One of the goals for a business owner in the culinary field is completion of a dish with consistent flavors regardless of chef rotation or store chain. In recent years, there has been rapid development of automatic equipment; if a kitchen is fully automated and personnel factors are removed, labor costs would be lowered, and management over operations would be more effective.

However, a conventional automatic culinary machine is usually designed around a specific dish, and replenishing ingredients, controlling temperatures, and cooking are all done by a single machine. While the conventional automatic culinary machine is able to automatically complete a dish, a single conventional automatic culinary machine has limited capacity and can only make a limited number of dishes within a certain period of time. As such, the conventional automatic culinary machine is not able to meet the requirements of restaurants that need large serving quantities. Hence, there is room for improvement.

### SUMMARY

Therefore, an object of the disclosure is to provide an automatic culinary system that can alleviate at least one of the drawbacks of the prior art.

According to the disclosure, the automatic culinary system is adapted to be disposed around a stove, a pot that is disposed on the stove, and a pot lid that openably covers the pot. The automatic culinary system includes a central control unit that is operable for generating an actuation signal, an actuation unit that is signally connected to the central control unit, a seasoning supply unit, a sauce supply unit, and a mixer unit. The actuation unit includes an overhead crane and a mechanical arm. The mechanical arm is connected to the overhead crane, and is adapted for obtaining ingredients from an ingredient preparation zone in accordance to the actuation signal and placing the ingredients into the pot. The seasoning supply unit is signally connected to the central control unit and the actuation unit, and includes a plurality of seasoning storage barrels adapted for storing different types of seasoning powder, a plurality of seasoning output modules respectively disposed on the plurality of seasoning storage barrels, and a seasoning operation interface signally connected to the plurality of seasoning output modules, and operable for outputting a seasoning amount signal to one of the plurality of seasoning output modules. The one of the plurality of seasoning output modules is operable in accordance to the seasoning amount signal for outputting one of the different types of seasoning powder from the respective one of the plurality of seasoning storage barrels. The sauce supply unit is signally connected to the central control unit and the actuation unit, and includes a plurality of sauce storage barrels adapted for storing different types of sauces, a plurality of sauce dispenser modules respectively disposed on the plurality of sauce storage barrels, and a sauce operation interface signally connected to the plurality of sauce dispenser modules, and operable for outputting a usage signal to one of the plurality of sauce dispenser modules. The one of the plurality of sauce dispenser modules is operable in accordance to the usage signal for outputting one of the different types of sauces from the respective one of the plurality of sauce storage barrels. The mixer unit is adapted to be connected to the pot lid, is signally connected to the central control unit, and includes a mixer mechanism adapted to be fixed to an inner side of the pot lid, and a mixer actuation mechanism adapted to be disposed on an outer side of the pot lid. The mixer actuation mechanism is operable for moving the pot lid between a closed position, where the pot lid covers the pot, and an opened position, where the pot lid is away from the pot.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic view illustrating an embodiment of an automatic culinary system according to the disclosure.

FIG. 2 is a fragmentary top view of the embodiment, illustrating a positional relationship between an actuation unit, a seasoning supply unit, a sauce supply unit, and a topping supply zone of the embodiment.

FIG. 3 is a schematic side view of the seasoning supply unit.

FIG. 4 is a schematic view of a mixer unit of the embodiment, illustrating the mixer unit moving a pot lid from an opened position to a closed position.

FIG. 5 is a schematic view of the mixer unit and a control module of a central control unit.

FIG. 6 is a schematic view of a sensor of the control module in operation.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

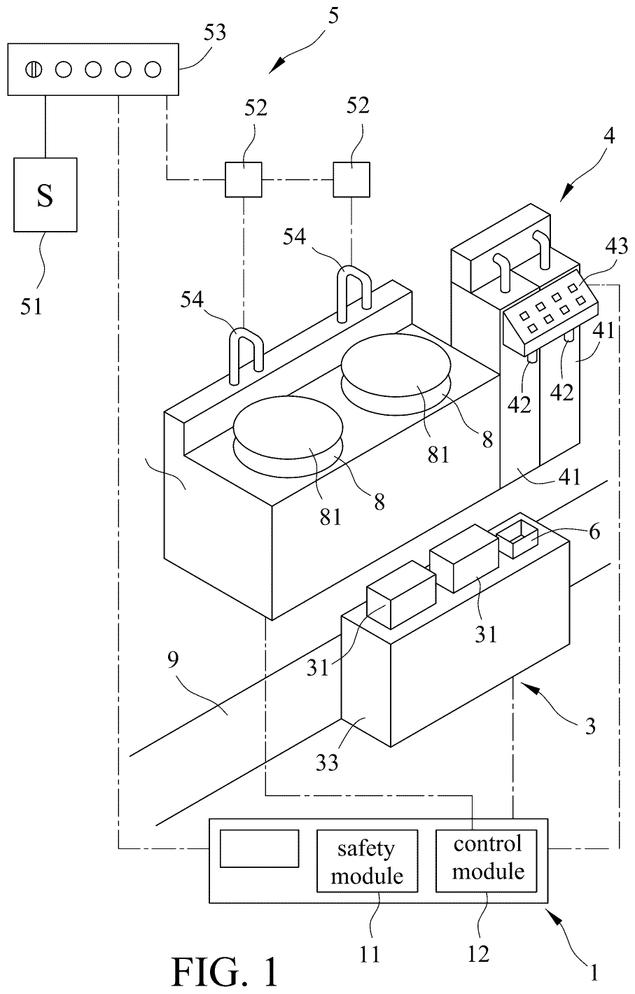

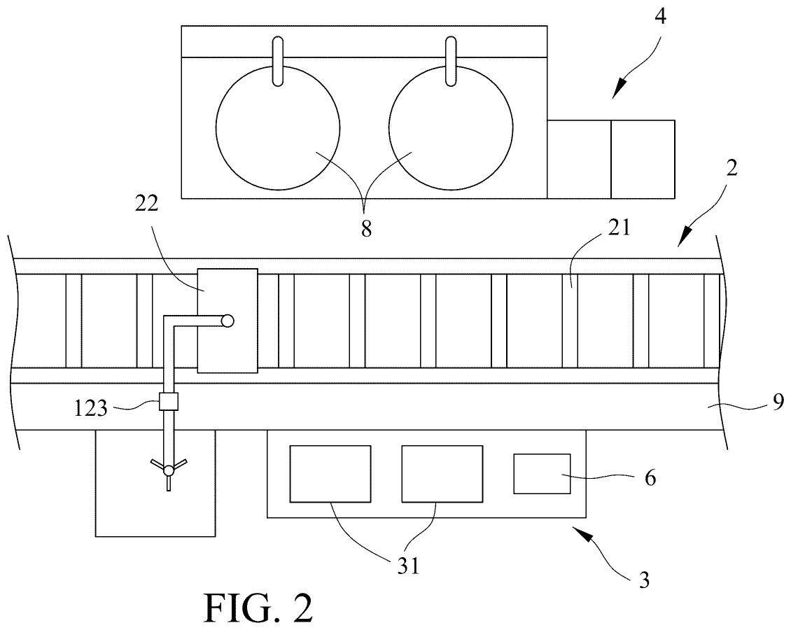

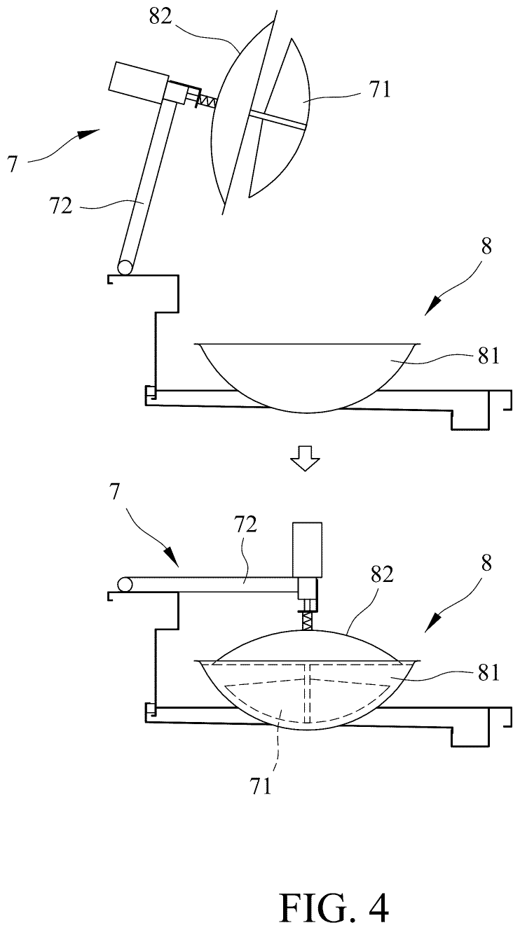

Referring to FIGS. 1 and 2, an embodiment of an automatic culinary system is adapted to be disposed around two stoves 8, two pots 81 that are respectively disposed on the stoves 8, two pot lids 82 (see FIG. 4 for one of the two lids 82) that openably and respectively cover the pots 81, and an aisle 9 that is proximate to and spaced apart from the stoves 8. The automatic culinary system includes a central control unit 1 that is operable for generating an actuation signal, an actuation unit 2 that is signally connected to the central control unit 1, a seasoning supply unit 3 that is signally connected to the central control unit 1 and the actuation unit 2, a sauce supply unit 4 that is signally connected to the central control unit 1 and the actuation unit 2, a water supply unit 5 that is signally connected to the central control unit 1, and a mixer unit 7 (see FIG. 4) that is adapted to be connected to the pot lids 82 and that is signally connected to the central control unit 1. In this embodiment, each of the stoves 8 is a gas stove, and the pots 81 are woks for pan-frying. In other embodiments, the pots 81 may be replaced by other types of pots and pans.

The central control unit 1 stores recipes and provides reference information on ingredients, topping serving sizes, seasoning powder serving sizes, sauce serving sizes, whether or not water is needed, and water serving sizes when water is needed according to the recipes. Specifically speaking, an operation method of the automatic culinary system includes setting up the central control unit 1 with dish recipes and serving quantities to choose from; and after a user chooses the dish and the serving quantity, the central control unit 1 providing reference information on serving sizes of ingredients, seasoning powder, toppings, and water to the actuation unit 2, the seasoning supply unit 3, the sauce supply unit 4 and the water supply unit 5 that are signally connected to the central control unit 1 for further operation. The central control unit 1 includes a safety module 11 adapted to be signally connected to the stoves 8, and adapted for controlling temperatures of the stoves 8, and a control module 12 adapted to be disposed on the pots 81 and signally connected to the mixer unit 7.

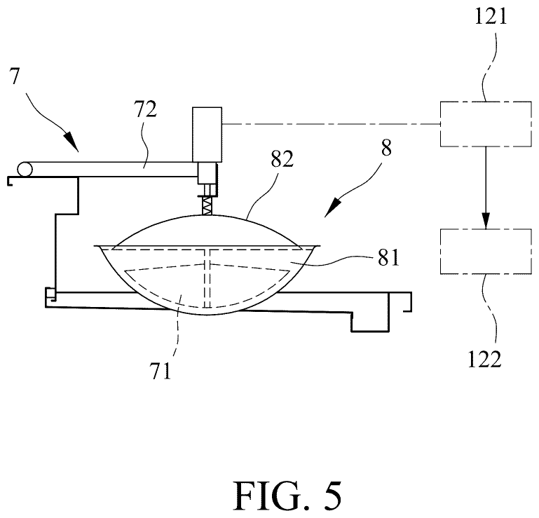

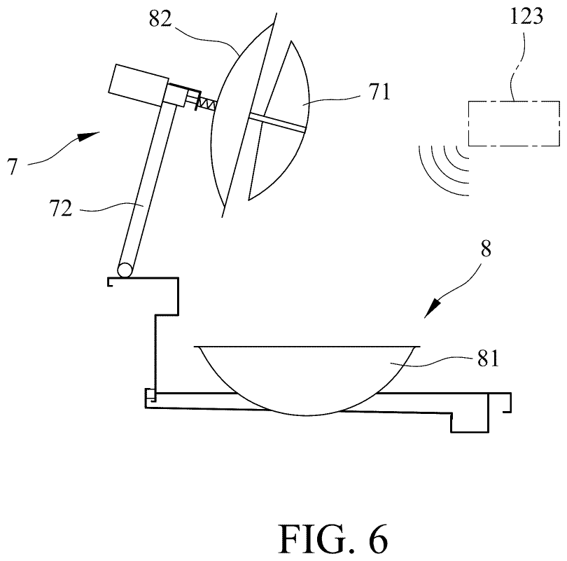

Specifically, referring to FIGS. 5 and 6, the control module 12 includes a detection member 121 that is disposed for detecting a rotation speed of the mixer unit 7 and generating a rotation speed signal, a reaction member 122 that is signally connected to the detection member 121, and a sensor 123 that is adapted to sense amounts of the ingredients, the different types of seasoning powder, the different types of sauces, and the water put into the pots 81. When the reaction member 122 receives the rotation speed signal, the reaction member 122 is configured to determine whether to output a warning signal.

Referring back to FIG. 2, the actuation unit 2 includes an overhead crane 21, and a mechanical arm 22 connected to the overhead crane 21 and adapted for obtaining ingredients from an ingredient preparation zone in accordance to the actuation signal and placing the ingredients into the pots 81. In this embodiment, the mechanical arm 22 is a collaborative robot (cobot); specifically, the mechanical arm 22 is a seven-axis collaborative robotic arm, which has more flexibility and higher movement efficiency compared to other robotic arms. The ingredient preparation zone is disposed adjacent to the aisle 9 such that the ingredient preparation zone does not obstruct the stoves 8 or intersect with a movement path of the mechanical arm 22. The ingredients and toppings (e.g., spring onions, onions, and garlic) are prepared beforehand at the ingredient preparation zone. In other embodiments where the ingredients and the toppings should be separately prepared, a topping supply zone 6 is disposed adjacent to the aisle 9, and the toppings are stored at the topping supply zone 6. A configuration of the overhead crane 21 allows the mechanical arm 22 to move along the overhead crane 21 without taking up space of the aisle 9 when the mechanical arm 22 obtains ingredients.

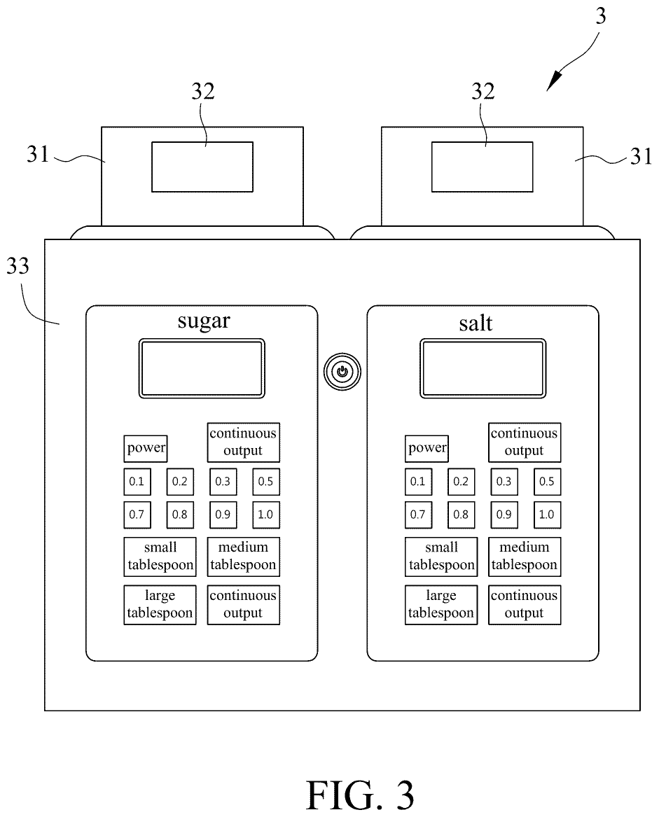

Referring to FIGS. 1 to 3, the seasoning supply unit 3 includes a plurality of seasoning storage barrels 31 respectively adapted for storing different types of seasoning powder, a plurality of seasoning output modules 32 respectively disposed on the seasoning storage barrels 31, and a seasoning operation interface 33 signally connected to the seasoning output modules 32, and operable for outputting a seasoning amount signal to one of the seasoning output modules 32. After the one of the seasoning output modules 32 receives the seasoning amount signal, the one of the seasoning output modules 32 operates in accordance to the seasoning amount signal and outputs one of the different types of seasoning powder from the respective one of the seasoning storage barrels 31. Referring to FIG. 3, the seasoning operation interface 33 provides type and serving size options for the mechanical arm 22 (see FIG. 2) to choose from. The seasoning operation interface 33 then generates and outputs a seasoning amount signal to a corresponding one of the seasoning output modules 32. The corresponding one of the seasoning output modules 32 then operates in accordance to the seasoning amount signal and outputs the seasoning powder from the respective one of the seasoning storage barrels 31 in a precise serving size that corresponds to the serving size option chosen. The serving sizes may be common measuring units, for example, teaspoons, or custom units like a volume of a wok ladle. Specifically, the seasoning powder stored in the seasoning storage barrels 31 may be, for example, salt, monosodium glutamate (MSG), sugar, or gorgon powder.

The sauce supply unit 4 includes a plurality of sauce storage barrels 41 adapted for storing different types of sauces, a plurality of sauce dispenser modules 42 respectively disposed on the sauce storage barrels 41, and a sauce operation interface 43 signally connected to the sauce dispenser modules 42, and operable for outputting a usage signal to one of the sauce dispenser modules 42. After the one of the sauce dispenser modules 42 receives the usage signal, the one of the sauce dispenser modules 42 operates in accordance to the usage signal and outputs one of the different types of sauces from the respective one of the sauce storage barrels 41. Specifically, the sauces in the sauce storage barrels 41 may be pastes or liquids, and may be, for example, soy sauce, soy sauce paste, black vinegar or cooking wine. An operation method of the sauce operation interface 43 is similar to an operation method of the seasoning operation interface 33. The sauce operation interface 43 provides sauce type options and serving size options for the mechanical arm 22 to choose from, and the sauce operation interface 43 generates a usage signal according to the choices made to a corresponding one of the sauce dispenser modules 42 disposed on the respective one of the sauce storage barrels 41 storing the sauce that corresponds to the sauce option chosen. The corresponding one of the sauce dispenser modules 42 then outputs the sauce from the respective one of the sauce storage barrels 41 in a precise serving size that corresponds to the serving size option chosen.

It should be noted that, for dishes that require cooking oils or aromatic oils, since the sauce storage barrels 41 are able to store pastes, the sauce storage barrels 41 are able to store and output oils that are normally viscous fluids to provide specific dishes with oils of precise serving sizes required to make the dish.

In this embodiment, the water supply unit 5 is adapted to be disposed adjacent to the stoves 8, and includes a water source 51, two control valves 52 that are connected to the water source 51, a water supply operation interface 53 that is signally connected to the control valves 52 and that is operable for outputting a water amount signal to the control valves 52, and two water output modules 54 that are respectively connected to the control valves 52 and that are operable for outputting water in accordance to the water amount signal. Specifically, after the mechanical arm 22 operates the water supply operation interface 53 to input a water serving size, the water supply operation interface 53 outputs a water amount signal according to the water serving size, and one of the control valves 52 opens for a specific amount of time to output a precise serving size of water from the water source 51 through a corresponding one of the water output modules 54. It should be noted that, in other embodiments, the seasoning operation interface 33, the sauce operation interface 43 and the water supply operation interface 53 may be operated by a user (specifically, the user being a human).

Referring to FIG. 4, the mixer unit 7 includes a mixer mechanism 71 adapted to be fixed to an inner side of each of the pot lids 82, and a mixer actuation mechanism 72 adapted to be disposed on an outer side of each of the pot lids 82. In this embodiment, only one mixer mechanism 71 is shown in FIGS. 4 and 5. The two mixer actuation mechanisms 72 are operable for moving the pot lids 82 between a closed position, where the pot lids 82 cover the pots 81, and an opened position, where the pot lids 82 are away from the pots 81. Specifically, a configuration of each of the mixer mechanisms 71 corresponds to a pot type of the pot 81; for example, in this embodiment, each of the mixer mechanisms 71 is a rotating mechanism connected to a stir-frying apparatus and configured to be combined with a wok. Each of the mixer actuation mechanisms 72 is a linkage mechanism, but in other embodiments, each of the mixer actuation mechanisms 72 may be other mechanisms that are simple to operate and that can move the pot lids 82 to the closed position.

Referring to FIGS. 1, 2 and 4, a method of operating the automatic culinary system is as follows. A user operates the central control unit 1 to choose a recipe and a serving size of a dish, and the central control unit 1 outputs the actuation signal to actuate the mechanical arm 22. Then, in response to the actuation signal, the mechanical arm 22 moves to obtain ingredients and operate the seasoning operation interface 33, the sauce operation interface 43, and the water supply operation unit 53 to obtain, respectively, seasoning powder, sauces and water of precise serving sizes. After obtaining the ingredients, toppings, seasoning powder, sauces and water, the mechanical arm 22 puts the ingredients, toppings, seasoning powder, sauces and water into one of the pots 81 according to the recipe of the dish, and the corresponding one of the mixer actuation mechanisms 72 moves the respective one of the pot lids 82 to the closed position. Then, the corresponding one of the mixer mechanisms 71 rotates to stir and fry the contents (i.e., the ingredients, toppings, seasoning powder, sauces and water) in the one of the pots 81 for a period of time according to the recipe of the dish until the dish is finished. Hence, the automatic culinary system is able to automatically complete dishes as needed.

It should be noted that, while different dishes have different cooking steps and different amounts of water that are called for, by uploading recipes of different dishes into the central control unit 1 beforehand, after the central control unit 1 receives the recipe of a chosen dish, the actuation unit 2, the seasoning supply unit 3, the sauce supply unit 4, the water supply unit 5, and the mixer unit 7 cooperate with each other in accordance to operation time each unit takes during each cooking step and the order of operations of each unit to complete the chosen dish. Furthermore, a station, with enough space for storage of seasoning powder, sauces and water, provides sufficient seasoning powder, sauces and water to the seasoning supply unit 3, the sauce supply unit 4, and the water supply unit 5, respectively, to ensure continuous output, thereby reducing the number of times to pause the cooking process to replenish seasoning powder, sauces and water, and ensuring a continuous operation of the automatic culinary system. Hence, the automatic culinary system benefits restaurant owners and scenarios that require large serving quantities.

Referring to FIGS. 5 and 6, it should be noted that, to ensure smoother operations, the control module 12 ensures the mixer mechanisms 71 are spinning correctly by detecting the rotation speeds of the mixer mechanisms 71 through the detection member 121 and generating a rotation speed signal. If the mixer mechanisms 71 are out of order or rotation is obstructed by the contents in the pots 81, the reaction member 122 outputs a warning signal after receiving the rotation speed signal, and in some embodiments, the reaction member 122 terminates operation of the mixer mechanisms 71 to prevent the mixer mechanisms 71 from further damage. Furthermore, the sensor 123 senses the ingredients, seasoning powder, sauces and water that are put into the pots 81 through an image recognition mechanism to ensure that the contents of the pots 81 correspond to the recipe of the dish provided by the central control unit 1. In other embodiments, the sensor 123 may use other methods, for example, by weighing the contents in the pots 81 or by using a charge-coupled Device (CCD) to achieve the same effect.

In conclusion, after the user inputs a dish and requirements for the dish through the central control unit 1, the central control unit 1 outputs an actuation signal to actuate the mechanical arm 22 to obtain toppings and ingredients from the ingredient preparation zone, to operate the seasoning supply unit 3, the sauce supply unit 4, and the water supply unit 5 to output, with precise serving sizes, seasoning powder, sauces/oils, and water, and to dispose the ingredients, toppings, seasoning powder, sauces/oils, and water into the pots 81. The mixer actuation mechanism 72 then moves the pot lids 82 to the closed position, the mixer mechanisms 71 stir the contents of the pots 81, and the stoves 8 cook the dishes until the dishes are completed. When there is constant provision of ingredients, seasoning powder, sauces/oils and water, the seasoning supply unit 3, the sauce supply unit 4, and the water supply unit 5 continuously output, in precise serving sizes, seasoning powder, sauces/oils and water, so that the dishes are automatically completed, which fulfills requirements of restaurants and scenarios where there is a need for a large quantity of servings. Hence, the objective of the disclosure is achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An automatic culinary system adapted to be disposed around a stove, a pot that is disposed on the stove, and a pot lid that openably covers the pot, the automatic culinary system comprising:
a central control unit that is operable for generating an actuation signal;
an actuation unit that is signally connected to said central control unit, and that includes
an overhead crane, and
a mechanical arm connected to said overhead crane and adapted for obtaining ingredients from an ingredient preparation zone in accordance to the actuation signal and placing the ingredients into the pot;
a seasoning supply unit that is signally connected to said central control unit and said actuation unit, and that includes
a plurality of seasoning storage barrels adapted for storing different types of seasoning powder,
a plurality of seasoning output modules respectively disposed on said plurality of seasoning storage barrels, and
a seasoning operation interface signally connected to said plurality of seasoning output modules, and operable for outputting a seasoning amount signal to one of said plurality of seasoning output modules, said one of said plurality of seasoning output modules being operable in accordance to the seasoning amount signal for outputting one of the different types of seasoning powder from the respective one of said plurality of seasoning storage barrels;
a sauce supply unit that is signally connected to said central control unit and said actuation unit, and that includes
a plurality of sauce storage barrels adapted for storing different types of sauces,
a plurality of sauce dispenser modules respectively disposed on said plurality of sauce storage barrels, and
a sauce operation interface signally connected to said plurality of sauce dispenser modules, and operable for outputting a usage signal to one of said plurality of sauce dispenser modules, said one of said plurality of sauce dispenser modules being operable in accordance to the usage signal for outputting one of the different types of sauces from the respective one of said plurality of sauce storage barrels; and
a mixer unit that is adapted to be connected to the pot lid, that is signally connected to said central control unit, and that includes
a mixer mechanism adapted to be fixed to an inner side of the pot lid, and
a mixer actuation mechanism adapted to be disposed on an outer side of the pot lid, said mixer actuation mechanism being operable for moving the pot lid between a closed position, where the pot lid covers the pot, and an opened position, where the pot lid is away from the pot.

2. The automatic culinary system as claimed in claim 1, further comprising a water supply unit that is signally connected to said central control unit, and that is adapted to be disposed adjacent to the stove, said water supply unit including a water source, a control valve that is connected to said water source, a water supply operation interface that is signally connected to said control valve and that is operable for outputting a water amount signal to said control valve, and a water output module that is connected to said control valve and that is operable for outputting water in accordance to the water amount signal.

3. The automatic culinary system as claimed in claim 2, wherein said mechanical arm is a collaborative robot.

4. The automatic culinary system as claimed in claim 2, wherein said central control unit includes a safety module adapted to be signally connected to the stove, and adapted for controlling a temperature of the stove.

5. The automatic culinary system as claimed in claim 4, wherein:
said central control unit further includes an control module signally connected to said mixer unit, said control module including a detection member that is disposed for detecting a rotation speed of said mixer mechanism and generating a rotation speed signal, and a reaction member that is signally connected to said detection member; and
said reaction member receives the rotation speed signal, and is configured to determine whether to output a warning signal.

6. The automatic culinary system as claimed in claim 2, wherein said central control unit further includes an control module adapted to be disposed on the pot, said control module including a sensor adapted to sense amounts of the ingredients, the different types of seasoning powder, the different types of sauces, and the water that are being put into the pot.

7. The automatic culinary system as claimed in claim 1, wherein said mechanical arm is a collaborative robot.

8. The automatic culinary system as claimed in claim 1, wherein said central control unit includes a safety module adapted to be signally connected to the stove, and adapted for controlling a temperature of the stove.

9. The automatic culinary system as claimed in claim 8, wherein:
said central control unit further includes an control module signally connected to said mixer unit, said control module including a detection member that is disposed for detecting a rotation speed of said mixer mechanism and generating a rotation speed signal, and a reaction member that is signally connected to said detection member; and
said reaction member receives the rotation speed signal, and is configured to determine whether to output a warning signal.
